(19) United States
(12) Patent Application Publication
(10) Pub. No.: US 2025/0326318 A1
(43) Pub. Date: Oct. 23, 2025

(54) CHARGING CONTROL DEVICE

(71) Applicant: Toyota Jidosha Kabushiki Kaisha, Toyota-shi (JP)

(72) Inventor: Yosuke WADA, Nagakute-shi (JP)

(73) Assignee: Toyota Jidosha Kabushiki Kaisha, Toyota-shi (JP)

(21) Appl. No.: 19/078,951

(22) Filed: Mar. 13, 2025

(30) Foreign Application Priority Data
Apr. 17, 2024 (JP) 2024-066739

(51) Int. Cl. B60L 53/66; B60L 58/12; B60L 58/16

(52) U.S. Cl. CPC B60L 53/66; B60L 58/12; B60L 58/16

(57) ABSTRACT

When charging is performed at home of a user of a vehicle, a processor performs first charging control to start the charging after an elapse of a standby time based on a time required for elimination of polarization of a battery pack and, when the charging is performed at a place other than the home, the processor performs second charging control to start the charging before the elapse of the standby time. The processor performs control to estimate the SOH, after each of the first charging control and the second charging control.

### CROSS REFERENCE TO RELATED APPLICATIONS

This nonprovisional application is based on Japanese Patent Application No. 2024-066739 filed on Apr. 17, 2024 with the Japan Patent Office, the entire contents of which are hereby incorporated by reference.

### BACKGROUND

### Field

The present disclosure relates to a charging control device.

### Description of the Background Art

Japanese Patent Laying-Open No. 2016-139525 discloses a battery mounted on a vehicle. In Japanese Patent Laying-Open No. 2016-139525, the SOC (State Of Charge) of the battery is calculated using an OCV (Open Circuit Voltage) when polarization occurring after charging of the battery is eliminated. Then, the life of the battery is determined using a capacity retention (SOH (State Of Health)) based on the calculated SOC.

### SUMMARY

However, it takes more than a certain time for polarization to be eliminated. Therefore, if, for example, there is no enough time and a standby time is provided for elimination of polarization, the battery (secondary battery) may not be charged sufficiently. In contrast, if the standby time for elimination of polarization is not provided, the SOH may be estimated inaccurately.

The present disclosure is given to solve the above problem, and an object of the present disclosure is to provide a charging control device capable of preventing the SOH of the secondary battery from being estimated inaccurately, while preventing charging from being insufficient.

A charging control device according to one aspect of the present disclosure is a charging control device that performs control for charging of a secondary battery mounted on a vehicle, and the charging control device includes: a first processor that performs control to estimate a state of health SOH of the secondary battery, using an amount of change in a state of charge SOC of the secondary battery at a time when the charging has been performed and using an amount of charging power at the time when the charging has been performed; and a second processor that controls the charging. When the charging is performed at home of a user of the vehicle, the second processor performs first charging control to start the charging after an elapse of a predetermined pre-charging standby time based on a time required for elimination of polarization of the secondary battery and, when the charging is performed at a place other than the home, the second processor performs second charging control to start the charging before the elapse of the pre-charging standby time. The first processor performs control to estimate the SOH after the charging by the first charging control or the second charging control is completed.

Thus, the charging control device according to one aspect of the present disclosure performs the first charging control to start charging after the elapse of the pre-charging standby time based on the time required for elimination of polarization of the secondary battery, when charging is performed at home of the user of the vehicle. When charging is performed at home, it is easy to have a relatively long charging time. Therefore, when charging is performed at home, it is easy to provide a standby time for elimination of polarization. It is therefore possible to accurately estimate the SOH after the first charging control at home. When charging is performed at a place other than home, second charging control is performed to start charging before the elapse of the pre-charging standby time. When charging is performed at a place other than home, it is more difficult to provide a standby time for elimination of polarization, as compared with the case where charging is performed at home. Therefore, if the pre-charging standby time is provided for the second charging control at a place other than home, it may be impossible to perform sufficient charging. In view of this, for the second charging control, charging is performed before the elapse of the pre-charging standby time, so that it is possible to prevent the secondary battery from being charged insufficiently. Accordingly, it is possible to prevent the SOH of the secondary battery from being estimated inaccurately, while preventing insufficient charging.

The first processor may perform control to estimate the SOH, after an elapse of a predetermined post-charging standby time based on a time required for elimination of polarization of the secondary battery from when the charging by the first charging control is completed. Such a configuration makes it possible to prevent the SOH from being estimated inaccurately due to polarization after charging by the first charging control.

When the charging is performed at a place other than the home and the user gives a command to perform the first charging control, the second processor may perform the first charging control instead of the second charging control. Such a configuration makes it possible to perform the first charging control, when charging is performed at a place other than home and the user wants polarization to be eliminated.

When the charging is performed at a place other than the home and the charging is scheduled to be performed longer than the pre-charging standby time by a predetermined time or more, the second processor may perform the first charging control instead of the second charging control. Even in the case where charging is performed at a place other than home, such a configuration makes it possible to perform charging after elimination of polarization, when there is a relatively long time for performing charging.

The charging control device may include a position information acquisition unit that acquires information about a position of the vehicle. Based on the information about the position of the vehicle acquired by the position information acquisition unit, the second processor may determine whether to perform the first charging control or the second charging control. Such a configuration makes it possible to determine whether to perform the first charging control or the second charging control, using the information from the position information acquisition unit included in the charging control device. Accordingly, as compared with the case for example where the above determination is made based on information transmitted from an external device such as server different from the charging control device, it is possible to increase the speed of processing by the charging control device and reduce the process load on the charging control device, because communication with the external device, for example, is unnecessary.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram illustrating a configuration of a charging system according to one embodiment.

FIG. 2 is a diagram showing a relationship between a charging time of a battery pack and an SOC thereof.

FIG. 3 is a diagram showing an SOC-OCV characteristic curve of the battery pack.

FIG. 4 is a flowchart showing control of an ECU according to one embodiment.

FIG. 5 is a flowchart showing control of an ECU according to a first modification of the embodiment.

FIG. 6 is a flowchart showing control of an ECU according to a second modification of the embodiment.

### DESCRIPTION OF THE PREFERRED EMBODIMENTS

Hereinafter, embodiments of the present disclosure will be described in detail with reference to the drawings. In the drawings, the same or corresponding parts are denoted by the same reference numerals, and the description thereof will not be repeated.

### Charging System Configuration

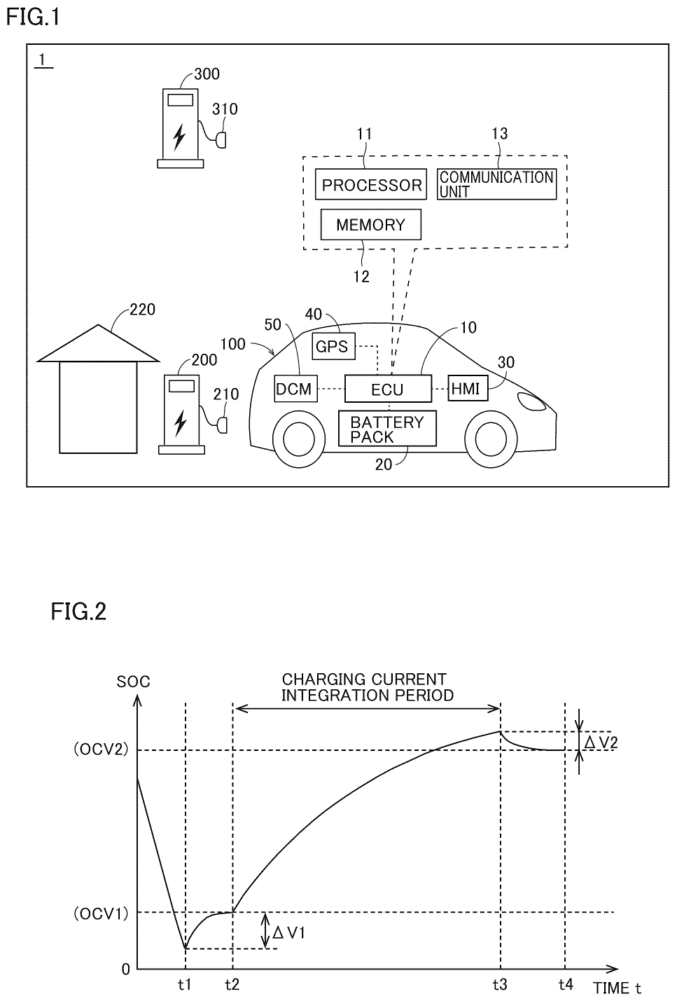

FIG. 1 is a diagram illustrating a configuration of a charging system 1 according to the present embodiment. The charging system 1 includes a vehicle 100 on which a battery pack (secondary battery) 20 described later is mounted, EVSE (Electric Vehicle Supply Equipment) 200, and at least one EVSE 300. The charging system 1 may include a plurality of EVSEs 300.

Examples of the vehicle 100 include PHEV (Plug-in Hybrid Electric Vehicle), BEV (Battery Electric Vehicle), and FCEV (Fuel Cell Electric Vehicle).

Vehicle 100 includes an electronic control unit (ECU) (charging control device) 10, a battery pack 20 (secondary battery), a human machine interface (HMI) device 30, a GPS (Global Positioning System) module 40, and DCM (Data Communication Module) 50. The ECU 10 is an example of the “charging control device” of the present disclosure.

The ECU 10 includes a processor (first processor) (second processor) 11, a memory 12, and a communication unit (position information acquisition unit) 13. The processor 11 executes various controls (for example, SOH estimation control and charging control of the battery pack 20, which will be described later.) related to charging of the battery pack 20. In addition to the program executed by the processor 11, the memory 12 stores information used in the program (for example, a map, a mathematical expression, and various parameters). The processor 11 is an example of the “first processor” and the “second processor” in the present disclosure. The communication unit 13 is an example of the “position information acquisition unit” in the present disclosure.

The communication unit 13 communicates with the battery pack 20, the HMI device 30, the GPS module 40, the DCM 50, and the like of the vehicle 100 by, for example, CAN (Controller Area Network) communication or the like. The communication unit 13 is controlled by the processor 11.

The battery pack 20 stores electric power used for driving (e.g., traveling) the vehicle 100. The battery cell provided in the battery pack 20 is configured by a secondary battery such as a lithium ion battery, a nickel-metal hydride battery, or a sodium-ion battery. The type of the secondary battery may be a liquid secondary battery or an all-solid secondary battery. A plurality of secondary batteries may form a battery assembly.

For example, the HMI device 30 transmits information of the vehicle 100 (for example, information of a remaining power amount, position information, and the like) to a user (occupant) of the vehicle 100. The HMI device 30 includes, for example, a car navigation device.

The GPS module 40 receives GPS signals transmitted from three or more (preferably four or more) satellites above the vehicle 100, and measures the position of the vehicle 100 (own vehicle). The position information of the vehicle 100 measured by the GPS module 40 is transmitted to the ECU 10 (communication unit 13) by CAN communication or the like. Note that the GPS module 40 may be incorporated in a car navigation device or the like included in the HMI device 30.

The DCM 50 is configured to be accessible to an external communication server, the Internet, or the like. Accordingly, the vehicle 100 can acquire various kinds of information from the outside of the vehicle through the DCM 50.

Each of the EVSE 200 and the EVSE 300 means a vehicle power supply facility (for example, a normal charging (AC charging) facility). The vehicle 100 is configured to be electrically connectable to the EVSE 200 or the EVSE 300. The battery pack 20 can be charged by electrically connecting the vehicle 100 to the EVSE 200 or the EVSE 300.

The EVSE 200 is a charging device provided at a home 220 of a user of the vehicle 100. The EVSE 300 is a charging device provided at a place other than the home 220 (for example, a shopping mall, a parking lot, and the like). The memory 12 of the ECU 10 stores position information of the home 220.

The EVSE 200 and the EVSE 300 have a charging plug 210 and a charging plug 310, respectively. When the charging plug 210 (310) is connected to an inlet (not shown) of the vehicle 100, the EVSE 200 (300) and the vehicle 100 are electrically connected to each other.

FIG. 2 is a diagram showing an example of a case where charging is performed after the vehicle is stopped. In FIG. 2, the horizontal axis represents time t, and the vertical axis represents SOC. Since the SOC and the OCV (Open Circuit Voltage) can be associated with each other, the SOC on the vertical axis can be read as the corresponding OCV.

The period until time t1 is a state in which the vehicle 100 is traveling. Since discharge in which the SOC of the battery pack 20 decreases is continued until time t1, polarization occurs in the battery pack 20 at time t1.

In the example of FIG. 2, the OCV rises as time elapses from time t1, and becomes substantially constant OCV1 at time t2. The increase in OCV between time t1 and time t2 is ΔV1. The magnitude of ΔV1 is the polarization voltage generated at time t1 immediately after the discharge is stopped. OCV1 is the original OCV at the time of discharge stop. The time t2 is a time at which charging of the battery pack 20 is started.

In the example of FIG. 2, the charging period is between time t2 and time t3. The ECU 10 sets this charging period as a charging current integration period. The ECU 10 integrates the current value supplied to the battery pack 20 with respect to the charging current integration period, and calculates the charging current integration value (Ah) in the charging period. The ECU 10 ends the charging, for example, when the charging for the predetermined charging execution time is completed. Alternatively, the ECU 10 ends the charging when the predetermined charging upper limit SOC is reached. In the example of FIG. 2, at time t3, the supply of charging power is stopped.

In the example of FIG. 2, the OCV decreases as time elapses from time t3, and becomes substantially constant OCV2 at time t4. The decrease in OCV between time t3 and time t4 is ΔV2. The magnitude of ΔV2 is the polarization voltage generated at time t3 immediately after the charging is stopped. OCV2 is the original OCV when charging is stopped.

Therefore, it is possible to accurately estimate the SOH using an accurate OCV by providing a standby time for eliminating polarization before and after the start of charging.

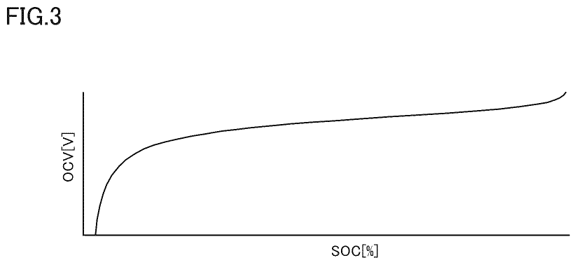

The ECU 10 calculates an amount of change in SOC based on a change in OCV due to charging of the battery pack 20 and an SOC-OCV characteristic curve (FIG. 3) indicating a relationship between a state of charge (SOC) and an open circuit voltage (OCV) of the battery pack 20. The ECU 10 calculates the current full charge capacity (capacity corresponding to SOC 100%) of the battery pack 20 by using the calculated amount of change in SOC and the amount of charging power based on the calculated charging current integrated value. The ECU 10 calculates the capacity retention (SOH) of the battery pack 20 by calculating the ratio between the calculated current full charge capacity and the initial full charge capacity. This is one example of the estimation control of the SOH of the battery pack 20. The information of the SOC-OCV characteristic curve shown in FIG. 3 may be stored in the memory 12 (FIG. 1), for example.

Here, it takes a certain time or more to eliminate the polarization as described above. For this reason, for example, if a standby time for eliminating polarization is provided when there is no allowance in time, the battery pack may not be sufficiently charged. On the other hand, if the standby time for eliminating the polarization is not provided, the estimation of the SOH is considered to be inaccurate. Therefore, when charging is performed at the home 220 of the user of the vehicle 100, the processor 11 executes the first charging control of starting charging after the elapse of the standby time (pre-charging standby time) T1 (for example, 30 minutes) based on the time required for depolarization of the battery pack 20. For example, the standby time T1 is set based on the time required for polarization occurring in the battery pack 20 after discharge to be eliminated. When charging is performed at a place other than the home 220, the processor 11 executes the second charging control for starting charging before the standby time T1 elapses. Then, the processor 11 performs control to estimate the SOH after the end of charging by the first charging control or the second charging control. Note that starting charging before the standby time T1 in the second charging control means starting charging without providing any standby time. The standby time T1 is an example of the “pre-charging standby time” in the present disclosure.

When charging is performed at the home 220, it is easy to secure a relatively long charging time because the charge rate does not change depending on the charging time and it is easy to perform charging at night. Therefore, charging can be sufficiently performed even when the standby time T1 for eliminating polarization is provided. On the other hand, when charging is performed at a place other than the home 220, the charging time becomes relatively short because the charge fee may change depending on the charging time and it is difficult to perform charging at night. Therefore, when the standby time T1 is provided, charging may be insufficient. In consideration of these conditions, the processor 11 is configured to execute the first charging control at the home 220 and to execute the second charging control in other than the home 220.

The standby time T1 may be derived by, for example, a test (Test to measure the time required for the polarization of the battery pack 20 after discharge to be resolved) performed at the time of manufacturing the battery pack 20. Information on the standby time T1 and a standby time (post-charging standby time) T2 described later may be stored in the memory 12.

### Control Flow of ECU

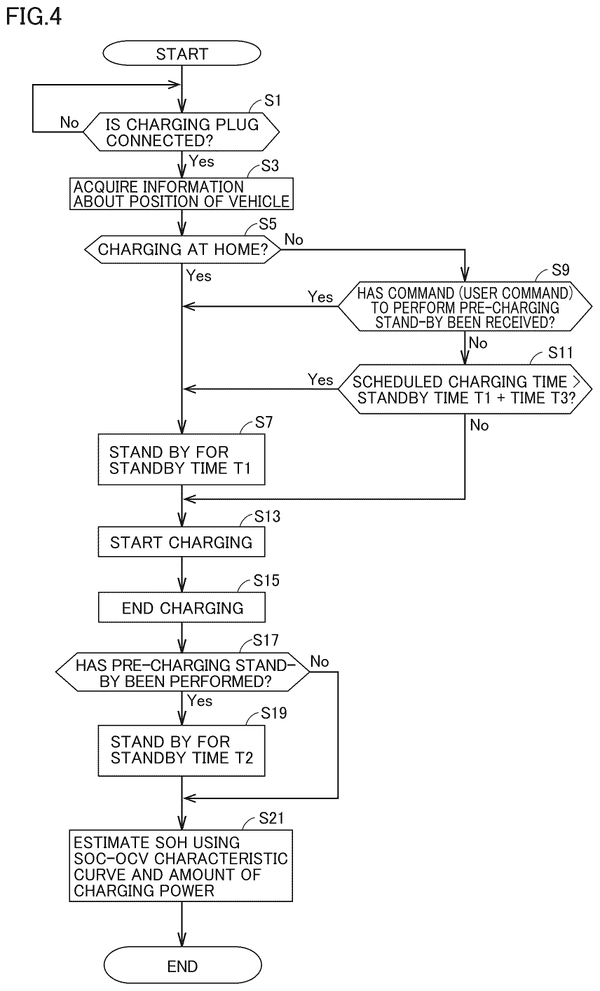

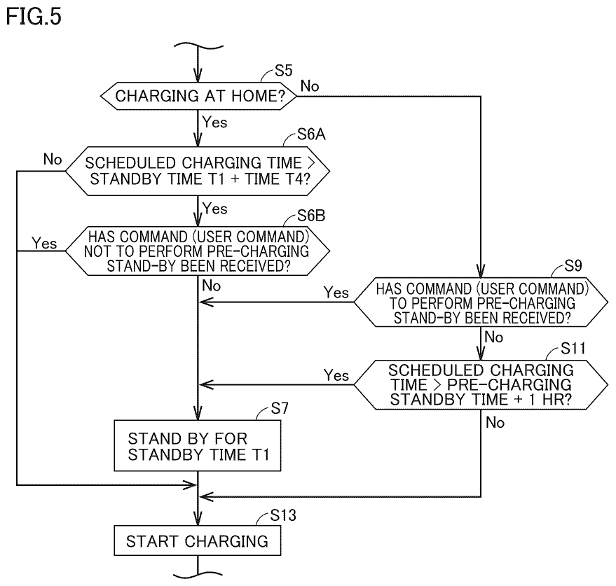

Next, a control flow of the ECU 10 will be described with reference to FIG. 4. Each process other than step S3 of the ECU 10 illustrated in FIG. 4 is executed by the processor 11, and the process of step S3 is performed by the communication unit 13.

In step S1, the ECU 10 determines whether the charging plug 210 or the charging plug 310 is connected to the vehicle 100 (inlet, not shown). When charging plug 210 or charging plug 310 is connected to vehicle 100 (Yes in S1), the process proceeds to step S3. When charging plug 210 or charging plug 310 is not connected to vehicle 100 (No in S1), the process of step S1 is repeated.

In step S3, the ECU 10 (communication unit 13) acquires the position information of the vehicle 100. Specifically, the communication unit 13 acquires the position information of the vehicle 100 measured by the GPS module 40 from the GPS module 40.

In step S5, the ECU 10 determines whether or not charging is performed at the home 220. Specifically, the ECU 10 determines that charging is performed using the EVSE 200 of the home 220 when the position information acquired in step S3 indicates the home 220, and determines that charging is performed using the EVSE 300 other than the home 220 when the position information indicates a position other than the home 220. When charging is performed in home 220 (Yes in S5), the process proceeds to step S7. When charging is not executed in home 220 (No in S5), the process proceeds to step S9. The ECU 10 performs the determination process of step S5 by comparing the position information of the home 220 stored in the memory 12 with the position information of the vehicle 100 measured by the GPS module 40.

In step S7, the ECU 10 stands by for the standby time T1. In other words, the ECU 10 waits for the standby time T1 without starting charging. Hereinafter, to stand by for the standby time T1 is referred to as execution of pre-charging stand-by.

In step S9, the ECU 10 determines whether or not the communication unit 13 has received a command (a command from the user) to perform pre-charging stand-by.

For example, when the user performs an operation of giving an instruction to perform pre-charging stand-by, on the HMI device 30 or the user terminal (for example, a smartphone, a PC, or the like), the communication unit 13 receives the command. When the command has been received (Yes in S9), the process proceeds to step S7. When the command has not been received (No in S9), the process proceeds to step S11. As described above, in the case of Yes in step S9, the ECU 10 executes the first charging control (charging after the standby time T1) instead of the second charging control (charging in which the standby time T1 is omitted).

In step S11, the ECU 10 determines whether or not the scheduled charging time is smaller than the sum (T1+T3) of the standby time T1 and the time T3 (for example, one hour). When the scheduled charging time is longer than the SUM (Yes in S11), the process proceeds to step S7. That is, the ECU 10 executes the first charging control instead of the second charging control. When the scheduled charging time is equal to or less than the SUM (No in S11), the process proceeds to step S13. The time T3 is an example of the “predetermined time” in the present disclosure. The information on the time T3 may be stored in the memory 12 (FIG. 1). In addition, each of the standby time T1 and the time T3 may be different for each vehicle 100 (vehicle type). As described above, in the case of Yes in step S11, the ECU 10 executes the first charging control (charging after the standby time T1) instead of the second charging control (charging in which the standby time T1 is omitted).

Note that the scheduled charging time may be, for example, a charging execution time set in advance by the user or a time until a time when the vehicle 100 is expected to move away from the EVSE 300. The time at which the user is expected to move away from the EVSE 300 may be predicted by the processor 11 based on, for example, the travel history of the vehicle 100, the travel schedule of the vehicle 100, the schedule of the user, the schedule of the facility or the like in which the EVSE 300 is installed (for example, the time of closing the store), and the like.

Note that the order in which the process of step S9 and the process of step S11 are executed may be opposite to that described above.

In step S13, the ECU 10 starts charging control of the battery pack 20. In step S15, the ECU 10 ends the charging of the battery pack 20. For example, the ECU 10 ends the charging control when a preset charging execution time has elapsed. Alternatively, the ECU 10 ends the charging control when the SOC reaches the charging upper limit SOC.

In step S17, the ECU 10 determines whether or not the pre-charging stand-by has been performed (i.e., whether or not the process of S7 has been performed). When the pre-charging stand-by has been performed (Yes in S17), the process proceeds to step S19. When the pre-charging stand-by has not been performed (No in S17), the process proceeds to step S21.

In step S19, the ECU 10 stands by for a standby time T2 (e.g., 30 minutes) based on the time required to eliminate the polarization of the battery pack 20. In other words, the ECU 10 stands by for the standby time T2 without estimating the SOH. For example, the standby time T2 is set based on the time required for eliminating polarization having occurred in the battery pack 20 after charging. Hereinafter, to stand by for the standby time T2 is referred to as execution of post-charging stand-by. The standby time T2 may be derived by, for example, a test (test to measure the time it takes for eliminating polarization after charging of battery pack 20) performed at the time of manufacturing the battery pack 20. The standby time T2 may be different for each vehicle 100 (vehicle type). Note that the standby time T2 may be equal to the standby time T1, or may be larger (or smaller) than the standby time T1. The standby time T2 is an example of the “post-charging standby time” in the present disclosure.

It is considered that there is a high possibility that the user of the vehicle 100 who has performed the standby before charging has a relatively long time. Therefore, in consideration of this condition, the ECU 10 is configured to execute the post-charging stand-by when the pre-charging stand-by is performed in step S17.

In step S21, as described above, the ECU 10 performs the process of estimating the SOH by using the SOC-OCV characteristic curve (FIG. 3) stored in the memory 12 (FIG. 1) and the amount of charging power by the charging. The process then ends.

As described above, in the present embodiment, when charging is performed at the home 220 of the user of the vehicle 100, the processor 11 executes the first charging control for starting charging after the elapse of the standby time T1. When charging is performed at a place other than the home 220, the processor 11 executes the second charging control for starting charging before the standby time T1 elapses.

Accordingly, at the home 220 in which the standby time T1 is easily secured, charging can be executed after stand-by before charging. As a result, SOH can be accurately estimated by eliminating polarization while suppressing insufficient charging. In addition, it is possible to execute charging while omitting the pre-charging stand-by at a place other than the home 220 where it is difficult to secure the standby time T1. As a result, insufficient charging can be suppressed.

### Modification

In the above embodiment, an example in which the post-charging stand-by is performed when the pre-charging stand-by is performed has been described, but the present disclosure is not limited thereto. Even when the pre-charging stand-by is performed, the post-charging stand-by may not be performed.

In the above-described embodiment, an example has been described in which the pre-charging stand-by is executed even at a place other than the home 220 when there is a user's command (Yes in S9) and when the scheduled charging time satisfies a predetermined condition (Yes in S11), but the present disclosure is not limited thereto. Only one of steps S9 and S11 may be performed. Further, neither of the determinations of steps S9 and S11 may be executed.

In the above embodiment, an example in which of the EVSE 200 of the home 220 and the EVSE 300 other than the home 220 is used is determined based on the information measured by the GPS module 40, but the present disclosure is not limited thereto. For example, the ECU 10 may determine which of the EVSE 200 and the EVSE 300 is used based on identification information (such as an EVSE-ID) transmitted from the EVSE to be used.

Although the ECU 10 of the vehicle 100 executes the determination processes illustrated in FIG. 4 in the above embodiment, the present disclosure is not limited thereto. For example, each determination process or the like described above may be executed by a user terminal (for example, a smartphone, a PC, or the like), an external server, or the like. In this case, the user terminal, the external server, or the like may communicate with the DCM 50 of the vehicle 100.

In the above embodiment, an example has been described in which the pre-charging stand-by is always executed when charging is performed at the home 220 (Yes in S5), but the present disclosure is not limited thereto. Even when charging is performed at the home 220, there may be a case where the pre-charging stand-by is not executed.

Specifically, as shown in FIG. 5, in the case of Yes in step S5, the process of step S6A is executed. In step S6A, the ECU 10 determines whether or not the scheduled charging time is larger than the sum (T1+T4) of the standby time T1 and the time T4 (for example, one hour). When the scheduled charging time is longer than the total (Yes in S6A), the process proceeds to step S6B. When the scheduled charging time is equal to or less than the total (No in S6A), the process proceeds to step S13. The time T4 may be different for each vehicle 100 (type of vehicle). The information of the time T4 may be stored in the memory 12 (FIG. 1).

In step S6B, the ECU 10 determines whether or not the communication unit 13 has received a command not to execute the pre-charging stand-by (a command from the user). For example, when the user performs an operation of instructing non-execution of the pre-charging stand-by in the HMI device 30 or the user terminal (for example, a smartphone, a PC, or the like), the communication unit 13 receives the instruction. When the command is received (Yes in S6B), the process proceeds to step S13. When the command is not received (No in S6B), the process proceeds to step S7.

Only one of steps S6A and S6B may be executed. The order of step S6A and step S6B may be reversed.

In the above embodiment, the example in which the post-charging stand-by is always executed when the pre-charging stand-by is performed has been described, but the present disclosure is not limited thereto. Even when the pre-charging stand-by is performed, the post-charging stand-by may not be performed.

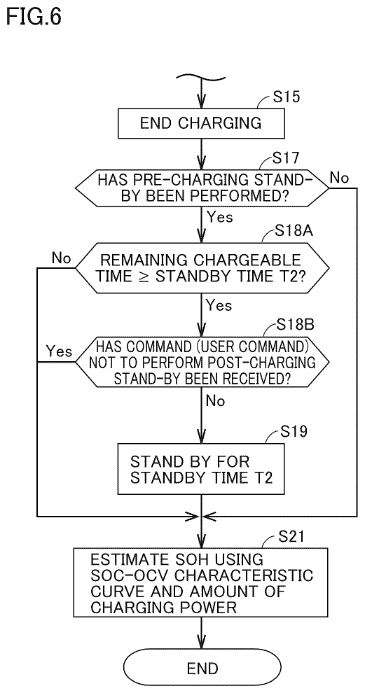

Specifically, as shown in FIG. 6, in the case of Yes in step S17, the process of step S18A is executed. In step S18A, the ECU 10 determines whether or not the remaining chargeable time is equal to or longer than the standby time T2. When the remaining chargeable time is equal to or longer than standby time T2 (Yes in S18A), the process proceeds to step S18B. When the remaining chargeable time is less than standby time T2 (No in S18A), the process proceeds to step S21. When the remaining chargeable time is less than standby time T2 (No in S18A), vehicle 100 may wait for the remaining chargeable time. In addition, the remaining chargeable time may be a remaining time of the charging execution time set in advance by the user or a time until a time when the vehicle 100 is expected to move away from the EVSE.

In step S18B, the ECU 10 determines whether or not the communication unit 13 has received a command not to execute the post-charging stand-by (a command from the user). For example, when the user performs an operation of instructing non-execution of post-charging stand-by in the HMI device 30 or the user terminal (for example, a smartphone, a PC, or the like), the communication unit 13 receives the instruction. When the command is received (Yes in S18B), the process proceeds to step S21. When the command is not received (No in S18B), the process proceeds to step S19.

Note that only one of steps S18A and S18B may be executed. The order of step S18A and step S18B may be reversed.

In the above embodiment, an example in which the processor 11 executes each of the estimation control of the SOH and the charging control of the battery pack 20 has been described, but the present disclosure is not limited thereto. The estimation control of the SOH and the charging control of the battery pack 20 may be executed by different processors.

In the above embodiment, an example in which the standby time before charging is 0 in a case where charging is performed at a place other than the home 220 has been described, but the present disclosure is not limited thereto. For example, in the above case, a standby time (e.g., 15 minutes) shorter than the standby time T1 may be provided. The same may be applied to the standby after charging. That is, in the case of No in step S17 (FIG. 4), the SOH estimation process may be executed after a standby time (for example, 15 minutes) shorter than the standby time T2.

Note that the configurations (processes) of the above-described embodiments and the above-described modifications may be combined with each other.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A charging control device that performs control for charging of a secondary battery mounted on a vehicle, the charging control device comprising:
a first processor that performs control to estimate a state of health SOH of the secondary battery, using an amount of change in a state of charge SOC of the secondary battery at a time when the charging has been performed and using an amount of charging power at the time when the charging has been performed; and
a second processor that controls the charging, wherein
when the charging is performed at home of a user of the vehicle, the second processor performs first charging control to start the charging after an elapse of a predetermined pre-charging standby time based on a time required for elimination of polarization of the secondary battery, and
when the charging is performed at a place other than the home, the second processor performs second charging control to start the charging before the elapse of the pre-charging standby time, and
the first processor performs control to estimate the SOH after the charging by the first charging control or the second charging control is completed.

2. The charging control device according to claim 1, wherein the first processor performs control to estimate the SOH, after an elapse of a predetermined post-charging standby time based on a time required for elimination of polarization of the secondary battery from when the charging by the first charging control is completed.

3. The charging control device according to claim 1, wherein when the charging is performed at a place other than the home and the user gives a command to perform the first charging control, the second processor performs the first charging control instead of the second charging control.

4. The charging control device according to claim 1, wherein when the charging is performed at a place other than the home and the charging is scheduled to be performed longer than the pre-charging standby time by a predetermined time or more, the second processor performs the first charging control instead of the second charging control.

5. The charging control device according to claim 1, further comprising a position information acquisition unit that acquires information about a position of the vehicle, wherein
based on the information about the position of the vehicle acquired by the position information acquisition unit, the second processor determines whether to perform the first charging control or the second charging control.
